(19) United States
(12) Patent Application Publication
(10) Pub. No.: US 2024/0337754 A1
(43) Pub. Date: Oct. 10, 2024

(54) LASER RADAR DEVICE AND SIGNAL PROCESSING DEVICE FOR LASER RADAR DEVICE

(71) Applicant: Mitsubishi Electric Corporation, Tokyo (JP)

(72) Inventors: Yusuke ITO, Tokyo (JP); Takayuki KITAMURA, Tokyo (JP); Nobuyuki YOSHIKAWA, Tokyo (JP); Masaharu IMAKI, Tokyo (JP)

(73) Assignee: Mitsubishi Electric Corporation, Tokyo (JP)

(21) Appl. No.: 18/745,429

(22) Filed: Jun. 17, 2024

Related U.S. Application Data
(63) Continuation of application No. PCT/JP2022/005314, filed on Feb. 10, 2022.

(51) Int. Cl. G01S 17/95; G01P 5/26; G01S 17/58

(52) U.S. Cl. CPC G01S 17/95; G01P 5/26; G01S 17/58

(57) ABSTRACT

A laser radar device according to the present disclosure technology includes a signal processing unit, in which the signal processing unit includes a wind field calculating unit, a blind region extracting unit, and a learning algorithm unit, the wind field calculating unit obtains a Doppler frequency from a peak position of a spectrum at each of observation points and calculates a wind velocity, the blind region extracting unit extracts a blind region on the basis of a geometrical relationship including a laser irradiation direction and disposition of a structure, and the learning algorithm unit includes a learned artificial intelligence, and estimates a wind velocity value in the blind region.

### CROSS REFERENCE TO RELATED APPLICATIONS

This application is a Continuation of PCT International Application No. PCT/JP2022/005314 filed on Feb. 10, 2022, which is hereby expressly incorporated by reference into the present application.

### TECHNICAL FIELD

The present disclosure technology relates to a laser radar device and a signal processing device for the laser radar device.

### BACKGROUND ART

A technique for measuring wind velocity using a laser radar device is known. The laser radar device is also referred to as a LiDAR device.

For example, Patent Literature 1 discloses a fog observation system including a laser radar device that measures an echo of light. In addition, Patent Literature 1 discloses a fog observation system including a wind distribution detecting means that detects a velocity distribution (that is, a wind field) of the atmosphere from observation results of a plurality of laser radar devices.

### CITATION LIST

### Patent Literatures

Patent Literature 1: JP 2001-281352 A

### SUMMARY OF INVENTION

### Technical Problem

In a case where the wind field in the observation environment is measured using measuring instruments, a blind spot caused by a structure such as a building can be eliminated by increasing the number of measuring instruments. However, there is a limit to increasing the number of measuring instruments, and depending on a place, there may be circumstances where it is simply not possible to arrange measuring instruments, such as on private land.

It is also conceivable to use a simulation using a large calculation resource such as a supercomputer in order to obtain the wind field of the observation environment. However, performing wind-condition simulation in real time lacks reality.

An object of the present disclosure technology is to solve the above problems and to provide a laser radar device that generates wind field data without a blind spot caused by a structure in a much shorter time than performing a fluid simulation.

### Solution to Problem

A laser radar device according to the present disclosure technology is a laser radar device including a signal processor, in which the signal processor includes a wind field calculator, a blind region extractor, and a learning algorithm calculator, the wind field calculator obtains a Doppler frequency from a peak position of a spectrum at each of observation points and calculates a wind velocity, the blind region extractor extracts a blind region on the basis of a geometrical relationship including a laser irradiation direction and disposition of a structure, and the learning algorithm calculator includes a learned artificial intelligence, and estimates a wind velocity value in the blind region.

### Advantageous Effects of Invention

A laser radar device LR according to the present disclosure technology has the above-described configuration, it is possible to generate wind field data without a blind spot caused by a structure in a much shorter time than performing a fluid simulation.

### BRIEF DESCRIPTION OF DRAWINGS

FIG. 1 is an explanatory diagram illustrating a phenomenon in which a blind region BA occurs, which is a problem of a laser radar device LR according to the present disclosure technology.

FIG. 2 is a block diagram illustrating a functional configuration of the laser radar device LR according to a first embodiment.

FIG. 3 is an explanatory diagram illustrating a configuration example of a beam scanning optical system 10 according to the first embodiment.

FIGS. 4A and 4B are examples of graphs representing beat signal in time domain.

FIG. 5 is an example of a map representing observation points of the laser radar device LR according to the first embodiment.

FIG. 6 is a diagram illustrating an example of a data table included in a signal processing unit 13 according to the first embodiment.

FIG. 7 is a diagram illustrating an example of a data table to which a field related to a blind region is added in a blind region extracting unit 13d of the signal processing unit 13 according to the first embodiment.

FIG. 8 is a diagram illustrating that a learning algorithm unit 13e of the signal processing unit 13 according to the first embodiment estimates wind velocity at an observation point in the blind region BA.

FIG. 9 is a diagram illustrating a case where a learning data set used for learning of artificial intelligence according to the present disclosure technology is created by actual measurement.

FIG. 10 is a diagram illustrating a learning phase of the artificial intelligence according to the present disclosure technology.

FIG. 11 is an example of a map in a case where the laser radar device LR according to the first embodiment is applied to navigation assistance for an aerial mobile object.

FIG. 12 is a diagram illustrating a blind region BA generated when the laser radar device LR according to the first embodiment scans a laser in an EL direction.

FIG. 13 is a block diagram illustrating a functional configuration of a laser radar device LR according to a second embodiment.

FIG. 14 is an explanatory diagram illustrating a contour of a hard target that can be measured by the laser radar device LR according to the second embodiment and a contour of a hard target that cannot be measured.

FIG. 15 is a diagram illustrating a blind region BA in a broad sense handled by a signal processing device according to a third embodiment.

### DESCRIPTION OF EMBODIMENTS

The present disclosure technology relates to a laser radar device and a signal processing device for the laser radar device. The laser radar device is also referred to as a coherent doppler LiDAR or simply a doppler LiDAR. In the present specification, the term laser radar device is used in a unified manner.

In the present specification, a name used as a common noun is not denoted by a reference sign, a name used as a proper noun indicating a specific thing is denoted by a reference sign, and both are distinguished. For example, when a laser radar device is used as a common noun, “laser radar device” or “LiDAR” is simply used, and when a laser radar device is used as a proper noun, “laser radar device LR” is used. Similarly, when a structure is used as a common noun, “structure” is simply used, and when a structure is used as a proper noun, “structure Str” is used. Hereinafter, similar rules apply to other terms.

### First Embodiment

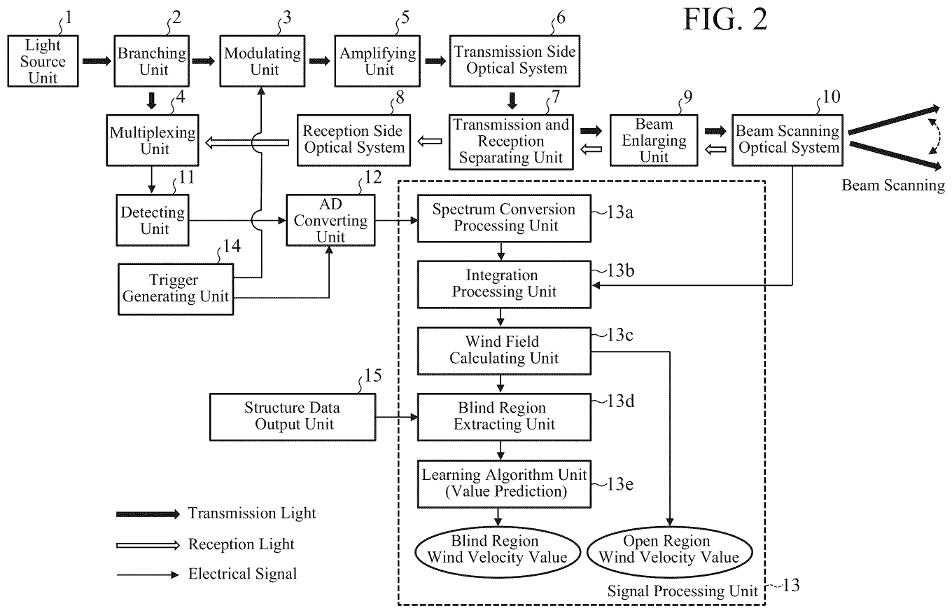

FIG. 2 is a block diagram illustrating a functional configuration of a laser radar device LR according to a first embodiment. As illustrated in FIG. 2, the laser radar device LR according to the first embodiment includes a light source unit 1, a branching unit 2, a modulating unit 3, a multiplexing unit 4, an amplifying unit 5, a transmission side optical system 6, a transmission and reception separating unit 7, a reception side optical system 8, a beam expanding unit 9, a beam scanning optical system 10, a detecting unit 11, an AD converting unit 12, a signal processing unit 13, a trigger generating unit 14, and a structure data output unit 15.

As illustrated in FIG. 2, the signal processing unit 13 of the laser radar device LR according to the first embodiment includes a spectrum conversion processing unit 13a, an integration processing unit 13b, a wind field calculating unit 13c, a blind region extracting unit 13d, and a learning algorithm unit 13e.

Each functional block of the laser radar device LR according to the first embodiment is connected as illustrated in FIG. 2. Arrows connecting the functional blocks illustrated in FIG. 2 represent one of transmission light, reception light, and an electrical signal.

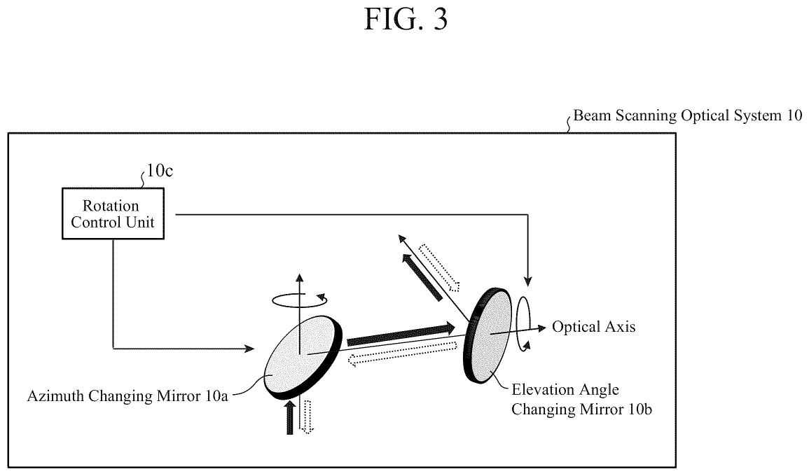

FIG. 3 is an explanatory diagram illustrating a configuration example of the beam scanning optical system 10 in the laser radar device LR according to the first embodiment. As illustrated in the drawings, the beam scanning optical system 10 of the laser radar device LR according to the first embodiment may include an azimuth changing mirror 10a, an elevation angle changing mirror 10b, and a rotation control unit 10c.

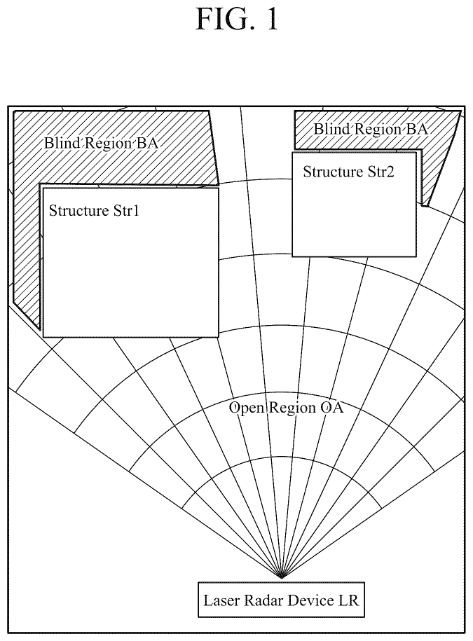

Arrows illustrated in FIG. 3 represent one of transmission light, reception light, and an electrical signal, similarly to FIG. 1.

### <<Light Source Unit 1>>

The light source unit 1 may be, for example, a semiconductor laser or a solid-state laser.

### <<Branching Unit 2>>

The branching unit 2 may be, for example, a 1:2 optical coupler or a half mirror.

### <<Modulating Unit 3>>

The modulating unit 3 may be, for example, an LN modulator, an AOM, or an SOA.

### <<Multiplexing Unit 4>>

The multiplexing unit 4 may be, for example, a 2:2 optical coupler or a half mirror.

### <<Amplifying Unit 5>>

The amplifying unit 5 may be, for example, an optical fiber amplifier.

### <<Transmission Side Optical System 6>>

The transmission side optical system 6 may include, for example, a convex lens, a concave lens, an aspherical lens, and a combination thereof. In addition, the transmission side optical system 6 may include a mirror.

### <<Transmission and Reception Separating Unit 7>>

The transmission and reception separating unit 7 may be, for example, a circulator or a polarization beam splitter.

### <<Reception Side Optical System 8>>

Similarly to the transmission side optical system 6, the reception side optical system 8 may include, for example, a convex lens, a concave lens, an aspherical lens, and a combination thereof. Similarly to the transmission side optical system 6, the reception side optical system 8 may include a mirror.

### <<Beam Expanding Unit 9>>

The beam expanding unit 9 may be, for example, a beam expander.

### <<Beam Scanning Optical System 10>>

The beam scanning optical system 10 may include, for example, a mirror or a wedge prism. The mirror may be a polygon mirror or a galvano mirror. As described above, a configuration example of the beam scanning optical system 10 is illustrated in FIG. 3. The rotation control unit 10c which is the component illustrated in FIG. 3 may include, for example, a motor and a motor driver.

### <<Detecting Unit 11>>

The detecting unit 11 may be, for example, a balanced receiver. The balanced receiver is also referred to as a balanced photodetector or simply a balanced detector. As a simplest case of a balanced receiver, one in which two photodiodes are connected so as to cancel each other's photocurrent is known. The balanced receiver has a function of converting an optical signal into an analog electrical signal and a function of amplifying and outputting the analog electrical signal.

### <<AD Converting Unit 12>>

The AD converting unit 12 may be a commercially available general-purpose analog to digital converter.

### <<Signal Processing Unit 13>>

The signal processing unit 13 is preferably configured by a processing circuit. The processing circuit may be dedicated hardware or a central processing unit (may also be referred to as a CPU, a central processor, a processing device, an arithmetic device, a microprocessor, a microcomputer, a processor, or a DSP) that executes a program stored in a memory. The processing circuit may be, for example, a single circuit, a composite circuit, a programmed processor, a parallel programmed processor, ASIC, FPGA, or a combination thereof.

As described above, the signal processing unit 13 does not need to be implemented by a large calculation resource such as a supercomputer, and may be a general personal computer.

### <<Trigger Generating Unit 14>>

The trigger generating unit 14 is preferably configured by a processing circuit similarly to the signal processing unit 13.

### <<Structure Data Output Unit 15>>

The structure data output unit 15 is a functional block for outputting data on the structure Str. Specifically, as the data about the structure Str, GPS data, terrain data, geographic data, drawing data by a user, data measured by LiDAR, or the like may be used.

### <<Operation of Laser Radar Device LR According to First Embodiment>>

The light source unit 1 outputs continuous wave light having a single frequency. The output continuous wave light is sent to the branching unit 2.

The branching unit 2 distributes the sent continuous wave light to two systems. A distributed part is sent to the modulating unit 3, and the remaining part is sent to the multiplexing unit 4. The continuous wave light sent to the multiplexing unit 4 is used as a reference, that is, reference light.

The trigger generating unit 14 generates a trigger signal having a predetermined repetition period. The trigger signal generated by the trigger generating unit 14 is sent to the modulating unit 3 and the AD converting unit 12. The voltage value and the current value of the trigger signal may be determined on the basis of specifications of the modulating unit 3 and the AD converting unit 12.

The modulating unit 3 converts the transmission light sent from the branching unit 2 into pulsed light on the basis of the trigger signal, and further adds a frequency shift. The transmission light processed by the modulating unit 3 is sent to the transmission side optical system 6 via the amplifying unit 5.

The transmission side optical system 6 converts the sent transmission light so as to have a designed beam diameter and beam divergence angle. The transmission light processed by the transmission side optical system 6 is sent to the beam scanning optical system 10 via the transmission and reception separating unit 7 and the beam expanding unit 9.

The beam scanning optical system 10 scans the sent transmission light toward the atmosphere. The term “scan” is synonymous with “scanning” and “perform scanning”. The scanning of the transmission light performed by the beam scanning optical system 10 changes an azimuth direction (hereinafter referred to as “AZ direction”), an elevation angle direction (hereinafter, “EL direction”), or both the AZ direction and the EL direction at a constant angular velocity, for example. Information of a beam scanning direction in the beam scanning optical system 10, specifically, information of an azimuth (θ_{AZ}) and an elevation angle (θ_{EL}) of the beam is sent to the integration processing unit 13b of the signal processing unit 13. Note that AZ in the AZ direction is the first two characters of the English name “azimuth” of the azimuth, and EL in the EL direction is the first two characters of the English name “elevation” of the elevation angle.

The transmission light scanned toward the atmosphere is scattered or reflected by a target such as aerosol in the atmosphere and a structure such as a building. A part of the scattered or reflected light is guided as reception light to the reception side optical system 8 via the beam scanning optical system 10, the beam expanding unit 9, and the transmission and reception separating unit 7.

The frequency of the reception light reflected by the aerosol in the atmosphere causes a Doppler shift corresponding to wind velocity as compared with the frequency of the transmission light. The laser radar device LR according to the present disclosure technology performs heterodyne detection, obtains the amount of Doppler shift corresponding to the wind velocity, and measures the wind velocity in a laser irradiation direction. Heterodyne is to generate a new frequency by synthesizing or multiplying two vibration waveforms. When the two frequencies are mixed, two new frequencies are generated due to the property of the trigonometric function. One is the sum of the two frequencies that are mixed, and the other is their difference. Heterodyne detection is a detection method using the heterodyne property.

The multiplexing unit 4 multiplexes and interferes the transmission light from the branching unit 2 and the reception light from the reception side optical system 8. The light multiplexed by the multiplexing unit 4 has a frequency of a difference between the frequency of the transmission light and the frequency of the reception light due to the heterodyne property, that is, a Doppler shift frequency (hereinafter simply referred to as a “Doppler frequency”). The signal multiplexed and interfered by the multiplexing unit 4 is referred to as an “interference beat signal” or simply a “beat signal”. The light multiplexed by the multiplexing unit 4 is sent to the detecting unit 11.

The detecting unit 11 converts the sent light into an analog electrical signal. The electrical signal processed by the detecting unit 11, that is, the beat signal is sent to the AD converting unit 12.

The AD converting unit 12 converts the beat signal of the analog electrical signal into a digital electrical signal, that is, a time-series digital signal in synchronization with the trigger signal. The time-series digital signals are sent to the spectrum conversion processing unit 13a of the signal processing unit 13.

The spectrum conversion processing unit 13a of the signal processing unit 13 divides the sent time-series digital signal by a predetermined time window length and repeatedly performs finite Fourier transform.

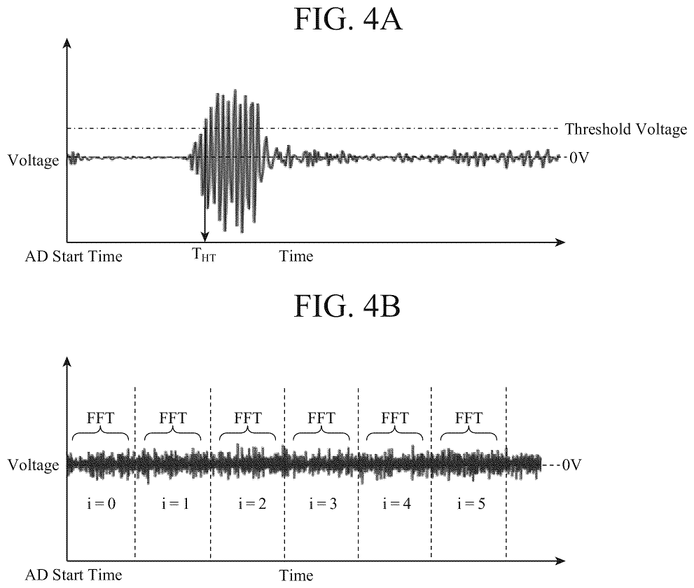

The graph in FIG. 4B illustrates a state in which the spectrum conversion processing unit 13a divides a signal by a predetermined time window length and repeatedly performs fast Fourier transformation (FFT) in each time window.

The time window length of the FFT in the spectrum conversion processing unit 13a determines a resolution in a range direction. The time window length (Δt) of the Fourier transform and the resolution (ΔL) in the range direction satisfy the following relationship.

$$Δ L = \frac{c Δ t}{2} \qquad ( 1 )$$

Here, c represents the speed of light. The relational expression (1) is based on the principle of time of flight (TOF). The reason why L is used as a symbol representing a range is that L is derived from an initial letter of Length which is an English name of a length.

The FFT in the spectrum conversion processing unit 13a is an FFT for obtaining a peak frequency of the beat signal, that is, the Doppler frequency.

FIGS. 4A and 4B are examples of graphs representing the beat signal in the time domain. The graph of FIG. 4B illustrates a case where the number of divisions (N) is 6. The signals in the time domain divided into six are information of six range bins when FFT processing is performed. Here, the term “bin” is synonymous with a bin or interval in a histogram. In the graph of FIG. 4B, i=0, 1, . . . , 5 are labels of range bins. The length (Lᵢ) indicated by the i-th range bin is obtained by multiplying the value (i) of the label number by the range direction resolution (ΔL).

The integration processing unit 13b of the signal processing unit 13 performs integration processing on spectrum data obtained by the FFT processing. The integration processing has an effect similar to that of the averaging processing and improves the SN ratio.

The time (Tᵢₙₜ) required for the integration processing is obtained as follows, where the number of integrations is M.

$${T}_{int} = \frac{M}{PRF} \qquad ( 2 )$$

However, PRF is a pulse repetition frequency. The inverse of the PRF is a period of a trigger.

The spectrum data processed by the integration processing unit 13b is sent to the wind field calculating unit 13c together with the information in the beam scanning direction from the corresponding beam scanning optical system 10. In the present specification, the information sent from the integration processing unit 13b to the wind field calculating unit 13c is represented by a symbol Sₙ (Lᵢ, θ_{AZ}, θ_{EL}, t). Here, t represents time. In addition, the subscript n is an index, and details of n will be apparent later.

As described above, the range direction resolution (ΔL) is determined by the time window length (Δt) of the FFT, but the angle resolution is determined by beam scanning speed of the beam scanning optical system 10.

For example, in the beam scanning optical system 10, it is assumed that the beam is fixed in the EL direction and is scanned at a constant angular velocity ω_{AZ} [deg/sec] in the AZ direction. As described above, since the time required for the integration processing is Tᵢₙₜ [sec], an angular resolution (Δω_{AZ}) in the AZ direction is a value obtained by multiplying the angular velocity ω_{AZ} by the integration processing time Tᵢₙₜ.

As described above, the information sent from the integration processing unit 13b to the wind field calculating unit 13c is Lᵢ, θ_{AZ}, θ_{EL}, and t, but since there is a range of time in the spectrum data (Sₙ) after the integration processing, it is a design matter to associate Lᵢ with θ_{AZ} and θ_{EL} at which time point. For the association, for example, an average value or a median value of θ_{AZ} and θ_{EL} in a time section of the integration processing (between time 0 and Tᵢₙₜ with the start time as 0) may be employed. In addition, θ_{AZ} and θ_{EL} at the start time point (time 0) or the end time point (time Tᵢₙₜ) of the integration processing may be employed as the association.

The wind field calculating unit 13c obtains a Doppler frequency from the peak position of the spectrum at each observation point where the wind velocity was observed, and calculates the wind velocity (v). When there is a plurality of peaks of the spectrum in the range bin, the Doppler frequency may be obtained by performing a centroid operation. The wind velocity (v) can be obtained from the following relational expression with the Doppler frequency (Δf).

$$v = \frac{λ}{2} Δ f \qquad ( 3 )$$

Here, λ is a wavelength of the laser beam output from the light source unit 1.

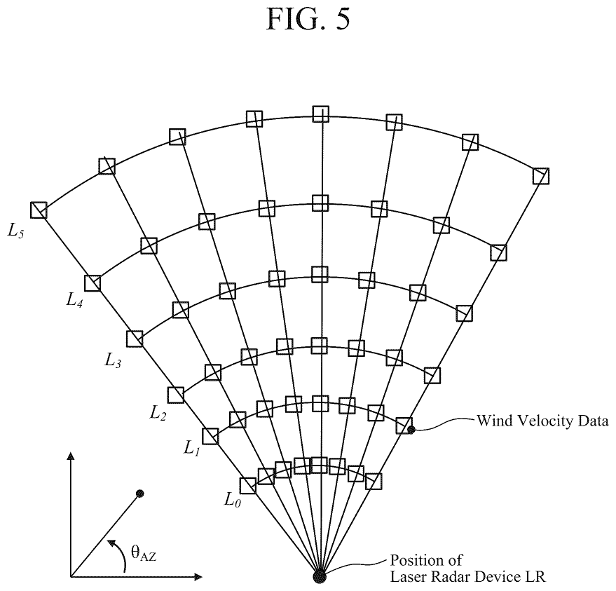

FIG. 5 is an example of a map representing observation points of the laser radar device LR according to the first embodiment. As illustrated in FIG. 5, the wind field calculating unit 13c calculates the wind velocity (v) at each of a plurality of observation points in the observation environment. The calculated wind velocity (v) at each observation point may be displayed as a “wind field” on the map.

As illustrated in Expression (3), the wind velocity (v) calculated based on the Doppler frequency is a velocity component in the laser irradiation direction and is a scalar value.

In order to clarify that the wind field is a type of “field” that depends on coordinates, hereinafter, the wind field is represented by a symbol vₙ (Lᵢ, θ_{AZ}, θ_{EL}). Note that, in a case where the transmission light is scanned only in the AL direction while the EL direction is fixed, the wind field may simply be expressed as vₙ (Lᵢ, θ_{AZ}) while omitting the coordinates in the EL direction. The subscript n used for the wind field is an index given for the wind field. Each square plot (□) in FIG. 5 represents a plurality of observation points in the observation environment. FIG. 5 illustrates the wind field of the observation environment as a whole.

The signal processing unit 13 including the wind field calculating unit 13c manages information regarding the wind field in a data table. In the data table, generally when represented in two dimensions, one row corresponds to one record, and a plurality of columns corresponds to a plurality of fields.

For example, the wind field calculating unit 13c may associate a row of the data table with the index (n) of the wind field. For example, the wind field calculating unit 13c may set the first column (field) as the length (Lᵢ) in the range direction, the second column (field) as the azimuth (θ_{AZ}) of the beam, and the third column (field) as the elevation angle (θ_{EL}) of the beam. Furthermore, the wind field calculating unit 13c may set the fourth column (field) as the time (t) and the fifth column (field) as the wind velocity (vₙ) at the n-th point.

The wind field data calculated by the wind field calculating unit 13c is sent to the blind region extracting unit 13d in the form of a data table.

The wind field (vₙ (Lᵢ, θ_{AZ}, θ_{EL})) formally calculated by the wind field calculating unit 13c also includes a wind field corresponding to an observation point corresponding to a blind region BA to be described later. When a hard target such as a structure is present at where the laser is emitted to, the laser is reflected without passing through the hard target, so that a point farther than the reflected position cannot be observed in principle. However, in such a situation, the reason why the formally calculated wind field (vₙ (Lᵢ, θ_{AZ}, θ_{EL})) includes the wind field corresponding to the observation point corresponding to the blind region BA is that so-called noise is formally treated as a “meaningful signal”. Even when the calculated wind velocity (v) is a value close to zero as a result of treating the noise as a “meaningful signal”, the calculated wind velocity (v) should not originally be treated as the wind velocity.

The structure data output unit 15 sends data regarding the structure to the blind region extracting unit 13d in the form of a data table. The data regarding the structure may be uniformly handled with the data of the wind field. Although details will be described later, the signal processing unit 13 manages the data of the wind field calculated by the wind field calculating unit 13c and the data regarding the structure output from the structure data output unit 15 in one data table.

The data regarding the structure may have, for example, a field common to the data regarding the wind field. Common fields may be, for example, a length (Lᵢ) in a range direction, an azimuth (θ_{AZ}), and an elevation angle (θ_{EL}). The length (Lᵢ), the azimuth (θ_{AZ}), and the elevation angle (θ_{EL}) in the range direction are coordinates of the observation point with the laser radar device LR as the origin.

The data table includes a field (str) for identifying whether or not the observation point is a structure. In this field (str), for example, 0 may be input in a case where the corresponding observation point is not a structure, and 1 may be input in a case where the corresponding observation point is a structure. That is, this field indicates a flag (str) indicating whether or not it is a structure.

The data regarding the structure output by the structure data output unit 15 fills Lᵢ, θ_{AZ}, θ_{EL}, and str in the fields of the data table.

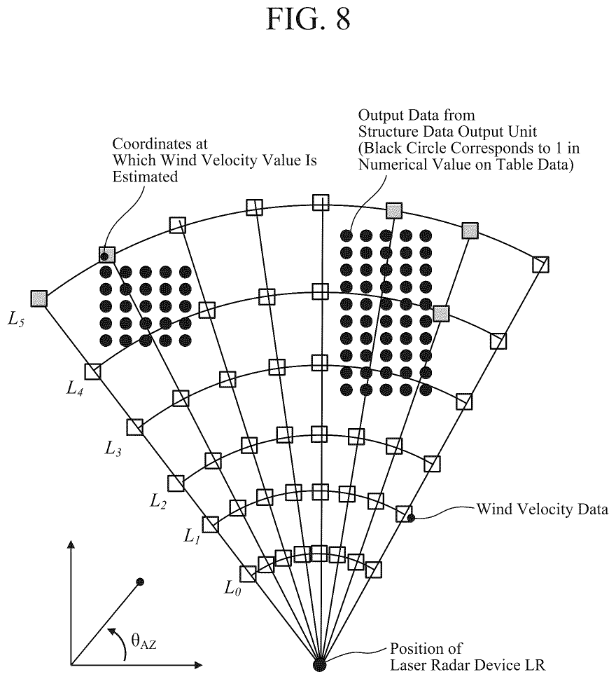

Here, the data regarding the structure output by the structure data output unit 15 does not need to have the same pitch (interval) as the wind field calculated by the wind field calculating unit 13c. Rather, the data regarding the structure output by the structure data output unit 15 desirably has a shorter pitch (interval) than the wind field calculated by the wind field calculating unit 13c. The reason for this becomes clear by considering extraction of the blind region BA to be described later (see FIG. 8).

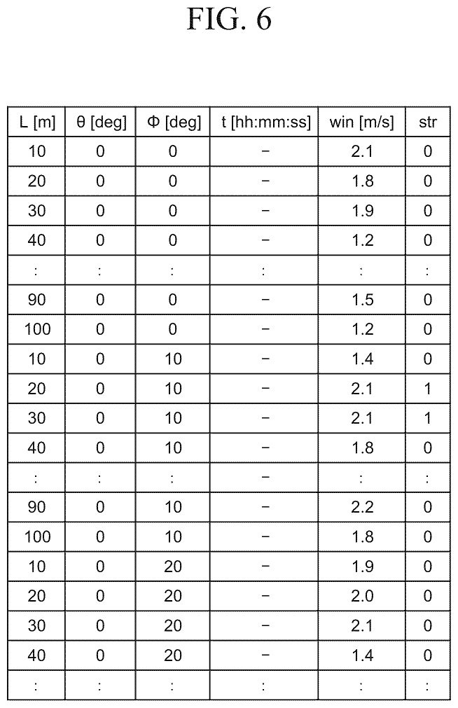

At this stage, the signal processing unit 13 has a data table having at least six types of fields. FIG. 6 is a diagram illustrating an example of a data table included in the signal processing unit 13 according to the first embodiment.

“L [m]” in the first column from the left illustrated in FIG. 6 is a field indicating a length (Lᵢ) in the range direction. “θ[deg]” in the second column from the left is a field indicating the azimuth (θ_{AZ}). “φ [deg]” in the third column from the left is a field indicating the elevation angle (θ_{EL}). “t [hh: mm: ss]” in the fourth column from the left is a field indicating time (t). “win [m/s]” in the fifth column from the left is a field indicating the wind velocity (vₙ). The field “str” in the sixth column from the left is a field indicating a flag (str) indicating whether or not it is a structure.

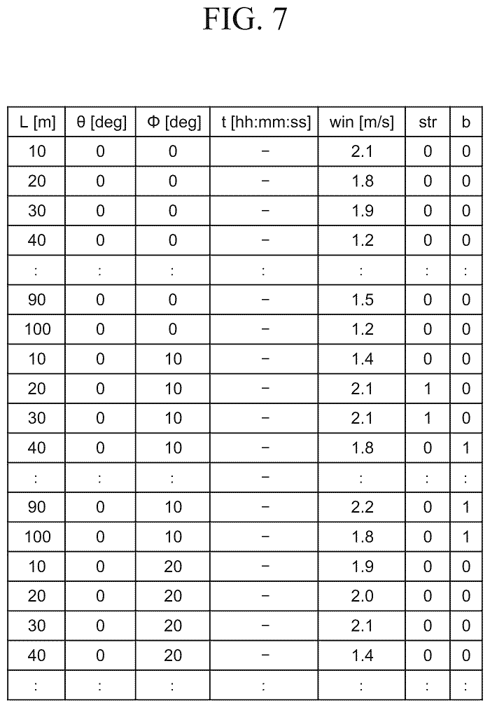

FIG. 7 is a diagram illustrating an example of a data table to which a field related to a blind region is added in the blind region extracting unit 13d of the signal processing unit 13 according to the first embodiment. As illustrated in FIG. 7, the blind region extracting unit 13d extracts the blind region BA on the basis of a geometric relationship including a laser irradiation direction and arrangement of structures. Here, the blind region BA is not a structure itself, but means a region of a space that a laser cannot reach due to a blind spot caused by the structure. The blind region BA is a region defined in the observation region. In the observation region, a region that is not the blind region BA is referred to as an “open region”.

“b” in the first column from the right illustrated in FIG. 7 indicates a flag (b) indicating whether or not the observation point is the blind region BA. In the example of FIG. 7, 0 is added when the corresponding observation point is not the blind region BA, and 1 is added when the corresponding observation point is the blind region BA.

The extraction of the blind region BA may be considered from the viewpoint of the irradiated laser (see FIGS. 7 and 8). That is, in the extraction of the blind region BA, the azimuth (θ_{AZ}) and the elevation angle (θ_{EL}) are fixed, and whether or not the structure is checked in the ascending order of the length (Lᵢ) in the range direction. After hitting the structure once, the length (Lᵢ) in the range direction is extended, and all the regions after the point where the structure is no longer existing are the blind regions BA.

At this stage, in addition to the above-described six types of fields, the signal processing unit 13 includes a data table having at least seven fields having a field indicating the flag (b) as to whether or not the region is the blind region BA. It can also be said that each row of the data table, that is, a record for each observation point, is represented by a 7-dimensional vector (Lᵢ, θ_{AZ}, θ_{EL}, t, vₙ, str, b).

The data of the data table having at least seven fields is sent to the learning algorithm unit 13e.

The learning algorithm unit 13e of the signal processing unit 13 is a functional block for estimating the wind velocity value in the blind region BA. FIG. 8 is a diagram illustrating that the learning algorithm unit 13e of the signal processing unit 13 according to the first embodiment estimates the wind velocity at the observation point in the blind region BA.

The learning algorithm unit 13e estimates the wind velocity value in the blind region BA by having an artificial intelligence configured by an artificial neural network or the like. The artificial neural network constituting the artificial intelligence may be, for example, a convolutional neural network (CNN).

A learning method of the artificial intelligence may be, for example, machine learning.

In addition, it is conceivable to create a learning data set used for learning of the artificial intelligence by various methods.

The learning data set may be created by performing fluid simulation using a large calculation resource such as a supercomputer, for example. The fluid simulation may use, for example, a technique of computational fluid dynamics (CFD, Computational Fluid Dynamics).

In addition, the learning data set may be created using data actually measured in various situations in the past.

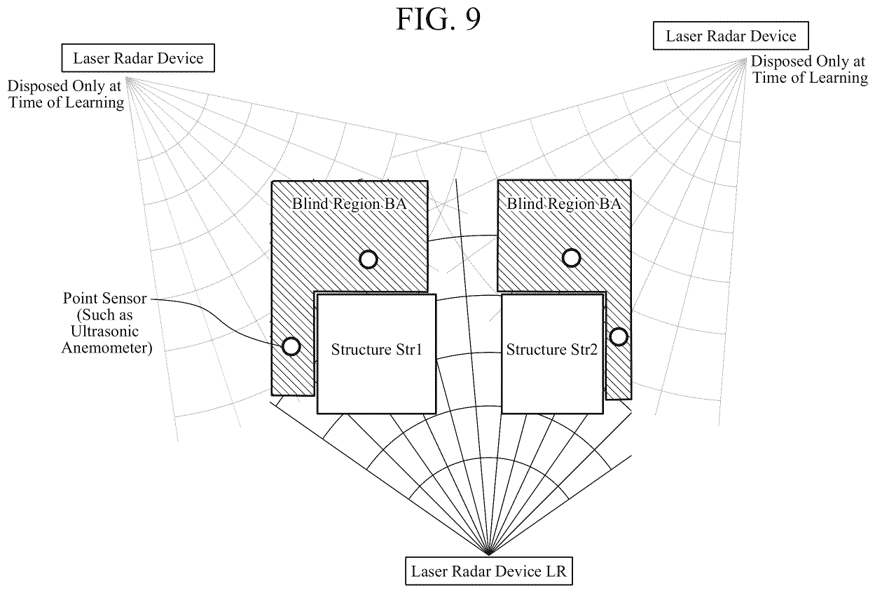

FIG. 9 is a diagram illustrating a case where a learning data set used for learning of the artificial intelligence according to the present disclosure technology is created by actual measurement. The learning data set includes an explanatory variable and an objective variable, and the objective variable, that is, the variable on the teacher data side is the wind velocity in the blind region BA.

As illustrated in FIG. 9, the wind velocity in the blind region BA as teacher data may be actually measured using a point sensor such as an ultrasonic anemometer. The wind velocity in the blind region BA serving as the teacher data may be actually measured by a laser radar device disposed only at the time of learning. Here, the laser radar device disposed only at the time of learning may have a configuration different from that of the laser radar device LR according to the present disclosure technology. The laser radar device disposed only at the time of learning may be, for example, a device that uses a chirp pulse, performs digital beam forming, or performs range FFT and Doppler FFT. In addition, the laser radar device disposed only at the time of learning does not need to include the artificial intelligence.

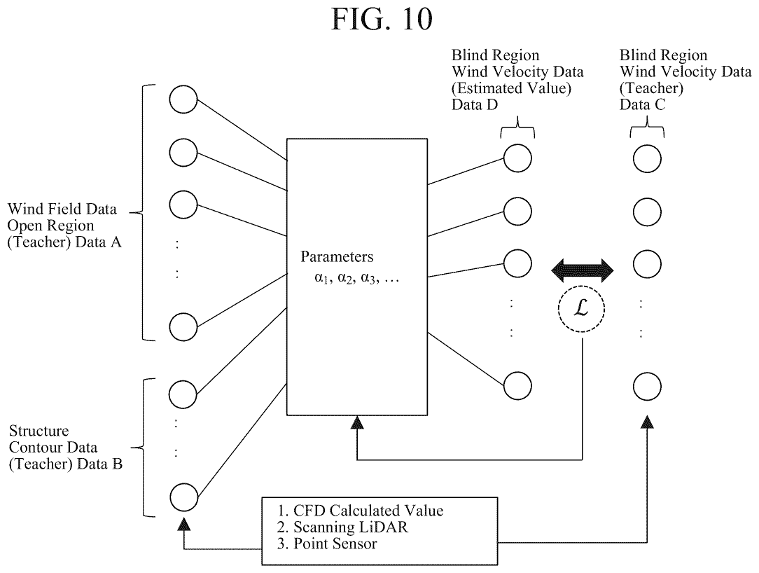

FIG. 10 is a diagram illustrating a learning phase of the artificial intelligence according to the present disclosure technology.

A rectangular vertically long block in the center of FIG. 10 represents the artificial intelligence. The artificial intelligence has its parameters (α₁, α₂, α₃, . . . ) optimized by learning.

The left side of the block representing the artificial intelligence is an explanatory variable of the learning data set, and is an input in the learned artificial intelligence. As illustrated in FIG. 10, the explanatory variables include a wind field data Open region (data A) and structure contour data (data B).

The right side of the block representing the artificial intelligence is an output of the artificial intelligence. As illustrated in FIG. 10, the output of the artificial intelligence is an estimated value (data D) of Blind region wind velocity data.

The rightmost side of FIG. 10 is an objective variable of the learning data set and is teacher data. As illustrated in FIG. 10, the teacher data is the Blind region wind velocity data (data C).

The block at the bottom of FIG. 10 indicates that the learning data set is created by, for example, a CFD calculated value, a scanning LiDAR, or a point sensor.

L of the script typeface in FIG. 10 represents an evaluation function. The evaluation function may include, for example, a term relating to an estimation error between the Blind region wind velocity data (data C) and the estimated value of the Blind region wind velocity data (data D). More specifically, the evaluation function may include a term representing an error between the Blind region wind velocity data (data C) and the estimated value of the Blind region wind velocity data (data D) in a quadratic form. The artificial intelligence according to the present disclosure technology advances learning by updating parameters (α₁, α₂, α₃, . . . ) so as to maximally digest the evaluation function.

Note that the display of “Blind region” in FIG. 10 is synonymous with the blind region BA.

The artificial intelligence included in the learning algorithm unit 13e is desirably learned using a learning data set in a situation that can be assumed as diverse as possible.

Note that the learning of the artificial intelligence may be performed in a development environment different from the signal processing unit 13 of the laser radar device LR. In this case, a mathematical model of the artificial intelligence learned in another development environment may be transferred to the learning algorithm unit 13e in a state of an optimized parameter after the learning is completed.

The learning algorithm unit 13e in an inference phase has a learned artificial intelligence, that is, a mathematical model having optimized parameters (α₁, α₂, α₃, . . . ).

The learning algorithm unit 13e in the inference phase generates an estimated value (data D) of the Blind region wind velocity data from the wind field data Open region (data A) and the structure contour data (data B) in the data table included in the signal processing unit 13.

The generation of the estimated value (data D) of the Blind region wind velocity data performed by the learning algorithm unit 13e in the inference phase is performed within a much shorter time than the fluid simulation.

As described above, since the laser radar device LR according to the first embodiment has the above-described configuration, it is possible to generate wind field data without a blind spot caused by a structure in a much shorter time than performing a fluid simulation.

### <<Application Example of Present Disclosure Technology>>

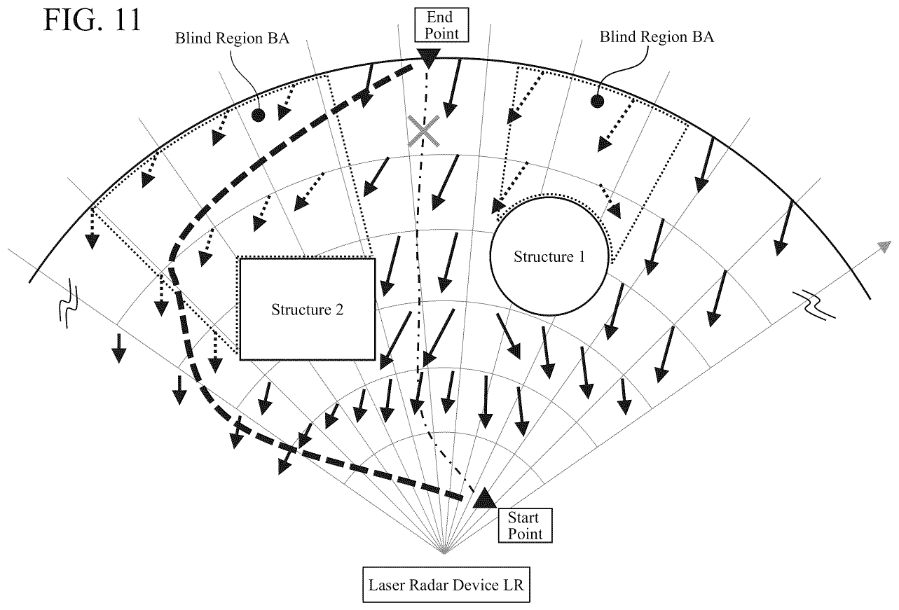

It is conceivable that the laser radar device LR according to the present disclosure technology is applied to navigation assistance for an aerial mobile object moving in the air, such as an aircraft or a drone, for example. FIG. 11 is an example of a map in a case where the laser radar device LR according to the first embodiment is applied to navigation assistance for an aerial mobile object.

A thick broken curve illustrated in FIG. 11 indicates a movement path of the aerial mobile object. A one-dot chain curve illustrated in FIG. 11 also illustrates a movement path of the aerial mobile object different from the thick broken curve. An upward black triangle “▴” illustrated in FIG. 11 represents a start point of a movement path, and a downward black triangle “▾” represents an end point of the movement path.

FIG. 11 illustrates a structure Str1 having a large round outline and a structure Str2 having a large square outline. An outer shape of each of a region that is a blind spot caused by the structure Str1 and a region that is a blind spot caused by the structure Str2 as viewed from the laser radar device LR is indicated by a closed dotted line as a blind region BA.

In FIG. 11, the wind direction and the wind velocity at a point in the open region are indicated by solid arrows (vectors). In FIG. 11, the wind direction and the wind velocity at a point in the blind region BA are indicated by dotted arrows (vectors). As described above, the wind velocity (v) calculated based on the Doppler frequency is a velocity component in the laser irradiation direction and is a scalar value. In order to obtain a wind velocity vector field like the AMeDAS live report (wind direction and wind velocity) provided by Japan Weather Association, it is necessary to measure the same observation environment by at least two laser radar devices in the case of two-dimensional observation and by at least three laser radar devices in the case of three-dimensional observation. A mode of using the plurality of laser radar devices LR will be apparent from the description of a third embodiment.

As illustrated in FIG. 11, since the wind field without the blind region BA caused by the structure Str can be obtained, the present disclosure technology can be applied to a navigation assistance system that formulates a movement path for an aerial mobile object moving in the air such as an aircraft or a drone.

The present disclosure technology has been described as a technology of a laser radar device, but is not limited thereto. In the present disclosure technology, for example, even in a system in which sensors such as ultrasonic anemometers are arranged in a crowd, the learning algorithm unit 13e may estimate the wind velocity (v) at the point of the blind region BA caused by the structure Str.

FIGS. 1, 5, 8, 9, and 10 illustrate a mode in which the laser radar device LR scans a laser in the AZ direction, but the present disclosure technology is not limited thereto.

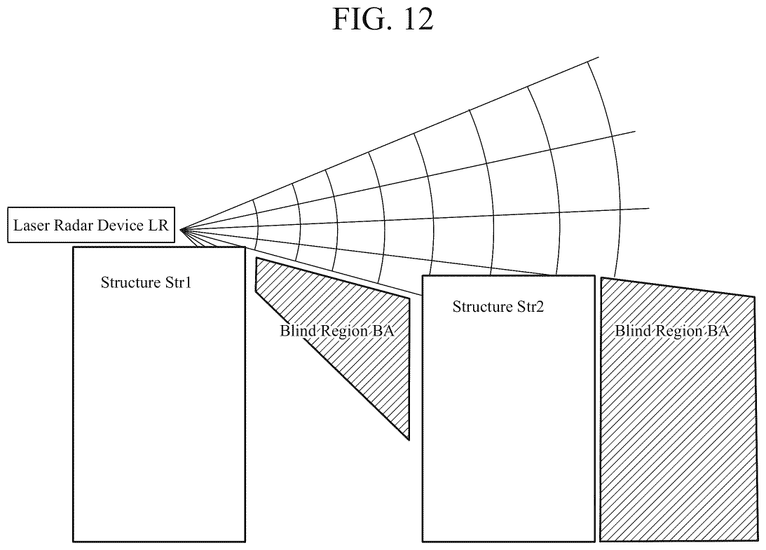

FIG. 12 is a diagram illustrating a blind region BA generated when the laser radar device LR according to the first embodiment scans the laser in the EL direction. The laser radar device LR according to the present disclosure technology can also estimate the wind velocity (v) for the blind region BA generated when the laser is scanned in the EL direction.

### Second Embodiment

A laser radar device LR according to a second embodiment illustrates a variation of the laser radar device LR according to the present disclosure technology. In the second embodiment, the same reference numerals as those used in the first embodiment are used unless otherwise specified. In the second embodiment, the description overlapping with the first embodiment is appropriately omitted.

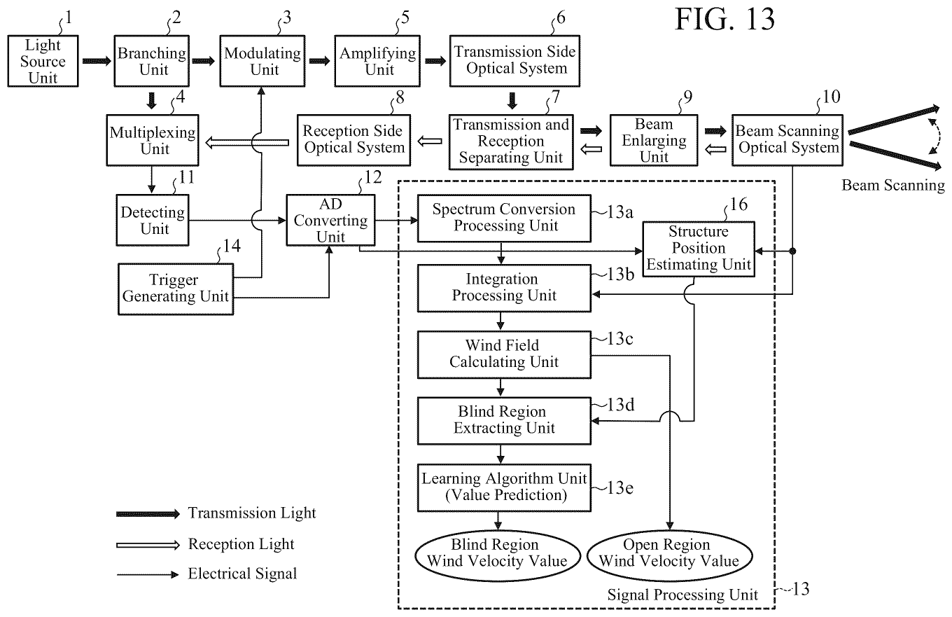

FIG. 13 is a block diagram illustrating a functional configuration of the laser radar device LR according to the second embodiment. As illustrated in FIG. 13, the laser radar device LR according to the second embodiment includes a structure position estimating unit 16 as a part of the signal processing unit 13 instead of the structure data output unit 15 according to the first embodiment.

### <<Structure Position Estimating Unit 16>>

The structure position estimating unit 16 of the signal processing unit 13 is a functional block for calculating information of the position and contour of the structure Str. The structure position estimating unit 16 is connected as illustrated in FIG. 13. Specifically, the structure position estimating unit 16 is connected to acquire information from the beam scanning optical system 10 and the AD converting unit 12, and output a result of performing estimation on the basis of the acquired information to the blind region extracting unit 13d.

As described above, FIGS. 4A and 4B are examples of graphs representing the beat signal in the time domain. The graph of FIG. 4A illustrates a beat signal when the emitted laser is reflected by the hard target. As illustrated in the graph of FIG. 4A, the beat signal in the case of being reflected by the hard target has such a high SN ratio that noise processing such as integration is unnecessary. That is, the magnitude of the signal is sufficiently larger than the magnitude of the noise.

The structure position estimating unit 16 compares the magnitude of the beat signal with a preset threshold. In a case where the magnitude of the beat signal exceeds the threshold, the structure position estimating unit 16 calculates a length (L_{HT}) from the laser radar device to the hard target from the time (T_{HT}) from the start of beam irradiation to the reception of a reflection signal exceeding the threshold. The length from the laser radar device to the hard target can be calculated as follows from the principle of TOF.

$${L}_{HT} = \frac{{cT}_{H T}}{2} \qquad ( 4 )$$

Note that the subscript HT is an acronym of Hard Target in English.

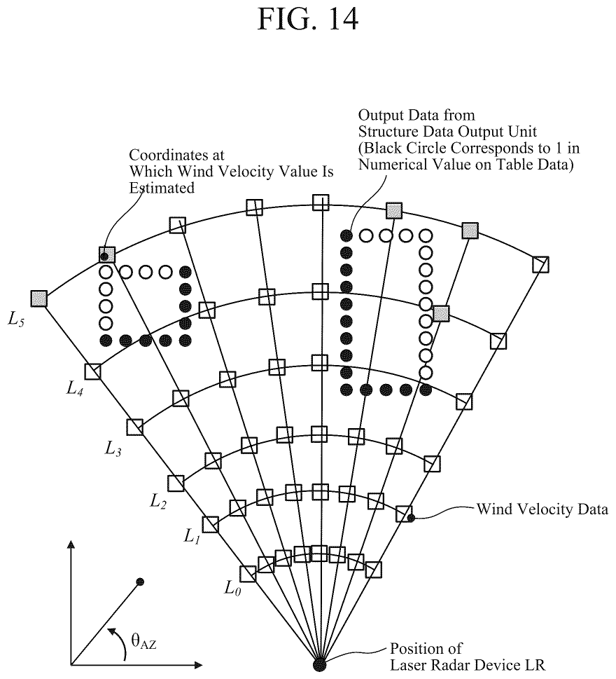

FIG. 14 is an explanatory diagram illustrating a contour of a hard target that can be measured by the laser radar device LR according to the second embodiment and a contour of a hard target that cannot be measured. In FIG. 14, black circles (●) indicate a contour of a hard target that can be measured by the laser radar device LR, and white circles (∘) indicate a contour of a hard target that cannot be measured by the laser radar device LR in FIG. 14. As illustrated in FIG. 14, when it is attempted to obtain position and contour information of a structure by the laser emitted by the laser radar device LR itself, information regarding a depth of the structure cannot be obtained.

However, if it is assumed that “the shape of the structure viewed from above is a quadrangle”, the structure position estimating unit 16 can also estimate a portion of a white circle (o) in FIG. 14. The structure position estimating unit 16 according to the second embodiment may estimate information of the position and the contour of the structure on the assumption that “the shape of the structure viewed from above is a quadrangle”.

Information of the position and the contour of the structure estimated by the structure position estimating unit 16 is sent to the blind region extracting unit 13d.

As described above, since the laser radar device LR according to the second embodiment has the above-described configuration, position and contour information of a structure can be obtained by the laser irradiated by the laser radar device LR itself, and wind field data having no blind spot of the structure can be generated within a much shorter time than the fluid simulation.

### Third Embodiment

The third embodiment illustrates a variation of the signal processing device according to the present disclosure technology. In the third embodiment, the same reference numerals as those used in the foregoing embodiments are used unless otherwise specified. In the third embodiment, the description overlapping with the previously described embodiments is appropriately omitted.

As described above, the wind velocity (v) calculated based on the Doppler frequency is a velocity component in the laser irradiation direction and is a scalar value. In order to obtain the wind velocity vector field like the AMeDAS live report (wind direction and wind velocity) provided by Japan Weather Association, it is necessary to measure the same observation environment by at least two laser radar devices in the case of two-dimensional observation and by at least three laser radar devices in the case of three-dimensional observation. The third embodiment illustrates a mode in which the signal processing device according to the present disclosure technology uses information from a plurality of laser radar devices LR.

The signal processing device according to the present disclosure technology may be either a part of the laser radar device LR or a separate device independent of the laser radar device LR.

In the previously described embodiments, the blind region BA is “a region of a space that is not a structure itself but is not reached by a laser due to a blind spot caused by the structure”. In the third embodiment, with the use of the plurality of laser radar devices LR, another extended definition is used for the blind region BA. The blind region BA in the third embodiment is also referred to as a blind region BA in a broad sense.

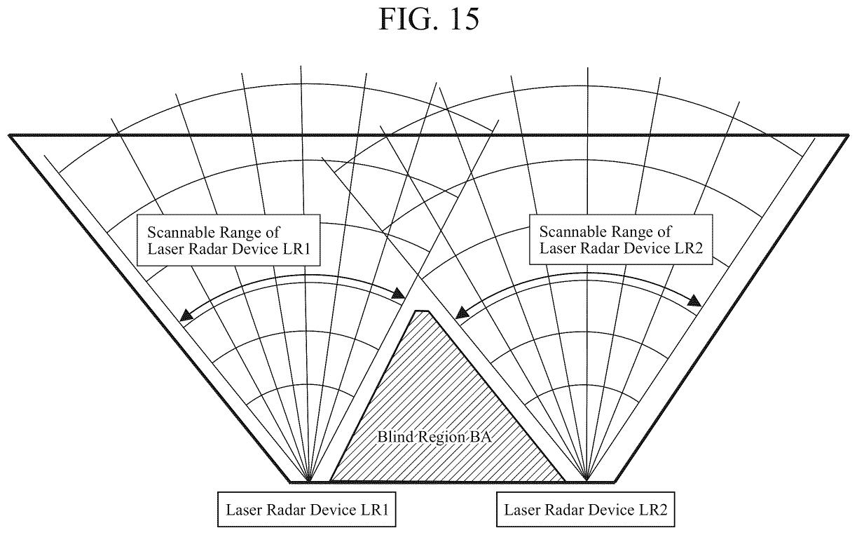

The blind region BA in the third embodiment is broadly defined as a “region of a space that is not reached by a laser”. FIG. 15 is a diagram illustrating a blind region BA in a broad sense handled by the signal processing device according to the third embodiment.

FIG. 15 illustrates a laser radar device LR1 and a laser radar device LR2. A hatched triangular region in FIG. 15 can be said to be one of blind regions BA in a broad sense.

As illustrated in FIG. 15, the present disclosure technology can handle a plurality of laser radar devices LR (laser radar device LR1, laser radar device LR2, . . . ). In this case, the signal processing device according to the present disclosure technology uses information from each laser radar device LR, and manages the used information in one data table. In the present disclosure technology, when the plurality of laser radar devices LR (laser radar device LR1, laser radar device LR2, . . . ) is used, the plurality of laser radar devices LR is controlled so as to measure the same observation point in the same observation region.

When there is one laser radar device LR, the observation point is specified by the length (Lᵢ) in the range direction, the azimuth (θ_{AZ}) of the beam, and the elevation angle (θ_{EL}) of the beam, and each is used as a field, but the signal processing device according to the present disclosure technology is not limited thereto.

The signal processing device according to the third embodiment may specify the observation point in any geographic coordinate system. That is, the field of the data table according to the third embodiment may be geographic coordinates for specifying an observation point instead of the length (Lᵢ) in the range direction, the azimuth (θ_{AZ}) of the beam, and the elevation angle (θ_{EL}) of the beam.

When the number of the laser radar devices LR is one, the wind field calculating unit 13c describes the wind velocity (vₙ) at the n-th point in the fifth column (field), which is a velocity component in the laser irradiation direction and has a scalar value.

In the third embodiment, it is assumed that two of the laser radar device LR1 and the laser radar device LR2 are used. Since the signal processing unit 13 according to the third embodiment can use information from the laser radar device LR1 and the laser radar device LR2, for one observation point,
the velocity component in the laser irradiation direction of the laser radar device LR1 and the velocity component in the laser irradiation direction of the laser radar device LR2 are known.

The wind field calculating unit 13c according to the third embodiment can describe the wind velocity vector (vₙ) at the n-th point in the field for the wind velocity.

The blind region extracting unit 13d according to the third embodiment may set a flag (that is, input 1) in a field indicating a flag (b) as to whether or not it is the blind region BA of a record of an observation point corresponding to the blind region BA in a broad sense in a data table in which information is used.

Similarly to the wind field calculating unit 13c according to the third embodiment calculating the wind velocity vector (vₙ), the learning algorithm unit 13e according to the third embodiment calculates an estimated value of the wind velocity vector (vₙ) for an observation point existing in the blind region BA.

The signal processing device according to the third embodiment includes a data table in which at least four types of fields of geographic coordinates for specifying an observation point, a wind velocity vector, a flag as to whether or not the observation point is a structure, and a flag as to whether or not the observation point is a blind region BA are included.

As described above, the present disclosure technology can generate the wind field including the wind velocity vector (vₙ) at the observation point, that is, the wind velocity vector field like the AMeDAS live report (wind direction and wind velocity) provided by Japan Weather Association even for the blind region BA in a broad sense within a much shorter time than performing the fluid simulation, using the plurality of laser radar devices LR (laser radar device LR1, laser radar device LR2, . . . ).

Note that the laser radar device LR and the signal processing device according to the present disclosure technology are not limited to the modes illustrated in the respective embodiments, and it is possible to combine the respective embodiments, to modify any component of the respective embodiments, or to omit any component in the respective embodiments.

### INDUSTRIAL APPLICABILITY

The laser radar device LR according to the disclosed technology can be applied to navigation assistance for an aerial mobile object moving in the air, such as an aircraft or a drone, and has industrial applicability.

### REFERENCE SIGNS LIST

1: light source unit, 2: branching unit, 3: modulating unit, 4: multiplexing unit, 5: amplifying unit, 6: transmission side optical system, 7: transmission and reception separating unit, 8: reception side optical system, 9: beam expanding unit, 10: beam scanning optical system, 10a: azimuth changing mirror, 10b: elevation angle changing mirror, 10c: rotation control unit, 11: detecting unit, 12: AD converting unit, 13: signal processing unit (signal processor), 13a: spectrum conversion processing unit, 13b: integration processing unit, 13c: wind field calculating unit (wind field calculator), 13d: blind region extracting unit (blind region extractor), 13e: learning algorithm unit (learning algorithm calculator), 14: trigger generating unit, 15: structure data output unit, 16: structure position estimating unit (structure position estimator).

What is claimed is:

1. A laser radar device comprising a signal processor, wherein
the signal processor includes a wind field calculator, a blind region extractor, and a learning algorithm calculator,
the wind field calculator obtains a Doppler frequency from a peak position of a spectrum at each of observation points and calculates a wind velocity,
the blind region extractor extracts a blind region by referring to a geometrical relationship including a laser irradiation direction and disposition of a structure, and
the learning algorithm calculator includes a learned artificial intelligence, and estimates a wind velocity value in the blind region.

2. A signal processing device that acquires and processes information from a laser radar device, the signal processing device comprising:
a wind field calculator, a blind region extractor, and a learning algorithm calculator, wherein
the wind field calculator obtains a Doppler frequency from a peak position of a spectrum at each of observation points and calculates a wind velocity,
the blind region extractor extracts a blind region by referring to a geometric relationship including a laser irradiation direction and disposition of a structure, and
the learning algorithm calculator includes a learned artificial intelligence, and estimates a wind velocity value in the blind region.

3. A signal processing device that acquires and processes information from a plurality of laser radar devices, the signal processing device comprising:
a wind field calculator, a blind region extractor, and a learning algorithm calculator, wherein
the wind field calculator obtains a Doppler frequency from a peak position of a spectrum at each of observation points and calculates a wind velocity vector,
the blind region extractor extracts a blind region by referring to a geometric relationship including a laser irradiation direction and disposition of a structure, and
the learning algorithm calculator includes a learned artificial intelligence, and calculates an estimated value of the wind velocity vector in the blind region.

4. The signal processing device according to claim 2, further comprising:
a data table including at least seven types of fields of a length in a range direction, an azimuth of a beam, an elevation angle of the beam, a time, a wind velocity, a flag as to whether or not it is a structure, and a flag as to whether or not it is a blind region.

5. The signal processing device according to claim 3, further comprising:
a data table including at least four types of fields of geographic coordinates for specifying an observation point, a wind velocity vector, a flag as to whether or not it is a structure, and a flag as to whether or not it is a blind region.

6. The signal processing device according to claim 2, further comprising:
a structure position estimator to estimate a position of a structure by referring to an assumption that a shape of the structure viewed from above is a quadrangle.
